(19) United States
(12) Patent Application Publication
(10) Pub. No.: US 2022/0275670 A1
(43) Pub. Date: Sep. 1, 2022

(54) VEHICLE DOOR LATCH

(71) Applicant: Inteva Products, LLC, Troy, MI (US)

(72) Inventors: Francisco Guevara Arreola, Shanghai (CN); Manuel Antonio Escamilla Hernandez, Ciudad Juárez (MX); Eduardo Estrada de Leon, CD. JUAREZ (MX); Martin Roman Villagrana Noris, Ciudad Juarez (MX)

(21) Appl. No.: 17/505,215

(22) Filed: Oct. 19, 2021

Related U.S. Application Data
(63) Continuation-in-part of application No. 17/187,757, filed on Feb. 27, 2021.

(51) Int. Cl. E05B 85/26; E05B 79/20; E05B 85/24; E05B 79/12; E05B 77/26

(52) U.S. Cl. CPC E05B 85/26; E05B 79/20; E05B 85/243; E05B 79/12; E05B 77/265; E05B 85/10

(57) ABSTRACT

A vehicle latch, including: a retention plate; a housing; a cover, the retention plate being secured to the housing and the housing is secured to the cover; a claw pivotally mounted to the retention plate; a pawl pivotally mounted to the retention plate; an outside handle lever securable to either a rod or a cable located outside of the housing of the latch; an inside release lever that is pivotally mounted to the housing via a pivot, the pivot being integrally formed with the housing such that they are formed as a single component, wherein the cover includes two retaining features to hold the inside release lever in position on the pivot, a first one of the two retaining features is located proximate to a tip of the pivot and a second one of the two retaining features is located at an opposite side of the tip of the pivot such that portions of the release lever is rotationally received between the two retaining features; and a fastener for securing the cover to the housing.

### CROSS REFERENCE TO RELATED APPLICATIONS

This application is a continuation-in-part of U.S. patent application Ser. No. 17/187,757 filed on Feb. 27, 2021 the entire contents of which are incorporated herein by reference thereto.

### BACKGROUND

Exemplary embodiments of the present disclosure pertain to the art of vehicle door latches.

Vehicle door latches include multiple components that cooperate with each other in order to provide operation of the vehicle door latch. In some applications, the latches must be reconfigured to be used with cables and/or rods. In addition, the latches will have a different configuration depending on their use as a rear door latch or as a front door latch.

As such, it is desirable to provide an improved vehicle door latch wherein the latch can be universal to a variety of designs and/or reduce the number of components required for operation of the latch.

### BRIEF DESCRIPTION

Disclosed is a vehicle latch, including: a retention plate; a housing; a cover, the retention plate being secured to the housing and the housing is secured to the cover; a claw pivotally mounted to the retention plate; a pawl pivotally mounted to the retention plate; and an outside handle lever securable to either a rod or a cable located outside of the housing of the latch.

Also disclosed is a vehicle latch, including: a retention plate; a housing; a cover, the retention plate being secured to the housing and the housing is secured to the cover; a claw pivotally mounted to the retention plate; a pawl pivotally mounted to the retention plate; an outside handle lever securable to either a rod or a cable located outside of the housing of the latch; an inside release lever that is pivotally mounted to the housing via a pivot, the pivot being integrally formed with the housing such that they are formed as a single component, wherein the cover includes two retaining features to hold the inside release lever in position on the pivot, a first one of the two retaining features is located proximate to a tip of the pivot and a second one of the two retaining features is located at an opposite side of the tip of the pivot such that portions of the release lever is rotationally received between the two retaining features; and a fastener for securing the cover to the housing.

In addition to one or more of the features described above, or as an alternative to any of the foregoing embodiments, the rod is secured to the outside handle lever with a rod lever pivotally mounted to the retention plate.

In addition to one or more of the features described above, or as an alternative to any of the foregoing embodiments, the outside handle lever is operatively coupled to a lock lever and the lock lever is operatively coupled to a pawl lifter, which is in turn coupled to the pawl.

In addition to one or more of the features described above, or as an alternative to any of the foregoing embodiments, the outside handle lever is spring biased a spring.

In addition to one or more of the features described above, or as an alternative to any of the foregoing embodiments, the outside handle lever is spring biased a spring.

In addition to one or more of the features described above, or as an alternative to any of the foregoing embodiments, the outside handle lever is operatively coupled to a lock lever and the lock lever is operatively coupled to a pawl lifter, which is in turn coupled to the pawl.

In addition to one or more of the features described above, or as an alternative to any of the foregoing embodiments, the cable is secured to the outside handle lever by a cable.

In addition to one or more of the features described above, or as an alternative to any of the foregoing embodiments, the outside handle lever is spring biased a spring.

In addition to one or more of the features described above, or as an alternative to any of the foregoing embodiments, the outside handle lever is operatively coupled to a lock lever and the lock lever is operatively coupled to a pawl lifter, which is in turn coupled to the pawl.

In addition to one or more of the features described above, or as an alternative to any of the foregoing embodiments, the cable passes through a cable connector that is secured to the housing.

In addition to one or more of the features described above, or as an alternative to any of the foregoing embodiments, an inside release lever is pivotally mounted to the housing via a pivot, wherein the pivot has a shoulder portion for retaining the inside release lever against the housing.

In addition to one or more of the features described above, or as an alternative to any of the foregoing embodiments, the inside release lever is operatively coupled to a lock lever such that movement of the inside release lever will cause the desired movement of lock lever and accordingly operation of the latch.

In addition to one or more of the features described above, or as an alternative to any of the foregoing embodiments, a spring provides a biasing force to the inside release lever.

In addition to one or more of the features described above, or as an alternative to any of the foregoing embodiments, a central door lock sector is provided and the central door lock sector is configured for use with the cable or the rod.

In addition to one or more of the features described above, or as an alternative to any of the foregoing embodiments, the vehicle latch includes a mechanical child lock mechanism, the mechanical child lock mechanism includes a child lock lever that is rotatably mounted to housing, a portion of the child lock lever extending through a slot in the housing which operably couples the child lock lever to a child lock link such that movement of the child lock lever will cause a corresponding movement of the child lock link, and the child lock lever includes a slot that allows a key or tool to be inserted into the slot in order to rotate the child lock lever, and an extension that extends from the child lock lever, the extension extends outwardly from the cover of the latch so that child lock lever may be manipulated without a tool or key inserted in slot.

In addition to one or more of the features described above, or as an alternative to any of the foregoing embodiments, the rod is secured to the outside handle lever with a rod lever pivotally mounted to the retention plate.

In addition to one or more of the features described above, or as an alternative to any of the foregoing embodiments, the outside handle lever is operatively coupled to a lock lever and the lock lever is operatively coupled to a pawl lifter, which is in turn coupled to the pawl.

In addition to one or more of the features described above, or as an alternative to any of the foregoing embodiments, a cable is secured to the outside handle lever.

In addition to one or more of the features described above, or as an alternative to any of the foregoing embodiments, the outside handle lever is operatively coupled to a lock lever and the lock lever is operatively coupled to a pawl lifter, which is in turn coupled to the pawl.

In addition to one or more of the features described above, or as an alternative to any of the foregoing embodiments, further including an inside release lever that is pivotally mounted to the housing via a pivot, wherein the pivot has a shoulder portion for retaining the inside release lever against the housing.

In addition to one or more of the features described above, or as an alternative to any of the foregoing embodiments, an inside release bypass lever is rotatably received on the pivot and the inside release lever is rotatably received on the inside release bypass lever.

In addition to one or more of the features described above, or as an alternative to any of the foregoing embodiments, the pivot the inside release bypass lever is integrally formed with a boss extending from the inside release bypass lever, the inside release bypass lever and the boss being formed as a single component and the inside release leaver is rotatably received on the boss of the inside release bypass lever pivot is integrally formed with the housing such that they are formed as a single component.

### BRIEF DESCRIPTION OF THE DRAWINGS

The following descriptions should not be considered limiting in any way. With reference to the accompanying drawings, like elements are numbered alike:

FIGS. 1A and 1B are perspective views of a vehicle latch in accordance with an embodiment of the present disclosure;

FIG. 2 is a view of components of a vehicle latch that is common for use with cable and rod operated mechanisms in accordance with an embodiment of the present disclosure, wherein the latch is in an engaged primary position and a rod is secured thereto;

FIGS. 3A and 3B are perspective views of components of a vehicle latch that is common for use with cable and rod operated mechanisms in accordance with an embodiment of the present disclosure, wherein the latch is in an engaged primary position and a rod is secured thereto;

FIG. 4 is a view of components of a vehicle latch that is common for use with cable and rod operated mechanisms in accordance with an embodiment of the present disclosure, wherein the release components of the latch are in a full open position and a rod is secured thereto;

FIG. 5 is a view of components of a vehicle latch that is common for use with cable and rod operated mechanisms in accordance with an embodiment of the present disclosure, wherein the latch is in an engaged primary position and a cable is secured thereto;

FIG. 6 is a view of components of a vehicle latch that is common for use with cable and rod operated mechanisms in accordance with an embodiment of the present disclosure, wherein the release components of the latch are in a full engaged position and a cable is secured thereto;

FIG. 7 is a view of components of a vehicle latch that is common for use with cable and rod operated mechanisms in accordance with an embodiment of the present disclosure, wherein the release components of the latch are in a full open position and a cable is secured thereto;

FIG. 8 is a view of components of a vehicle latch that is common for use with cable and rod operated mechanisms in accordance with an embodiment of the present disclosure, wherein the latch is in an engaged primary position and a cable conduit end-fitting is secured to the latch housing;

FIGS. 9 and 10A are portions of the vehicle latch showing a pivot for components of the latch in accordance with an embodiment of the present disclosure;

FIGS. 10B and 10C illustrate portions of the vehicle latch in accordance with an alternative embodiment of the present disclosure;

FIGS. 11 and 12 are views of components of a vehicle latch that is common for use with cable and rod operated mechanisms in accordance with an embodiment of the present disclosure, wherein a central door lock sector design common for both cable and rod operated latched is illustrated;

FIGS. 13A and 13B illustrate a mechanical child lock mechanism for use with a vehicle latch in accordance with an embodiment of the present disclosure; and

FIGS. 14A and 14B illustrate components of the mechanical child lock mechanism illustrated in FIG. 13.

### DETAILED DESCRIPTION

A detailed description of one or more embodiments of the disclosed apparatus and method are presented herein by way of exemplification and not limitation with reference to the Figures.

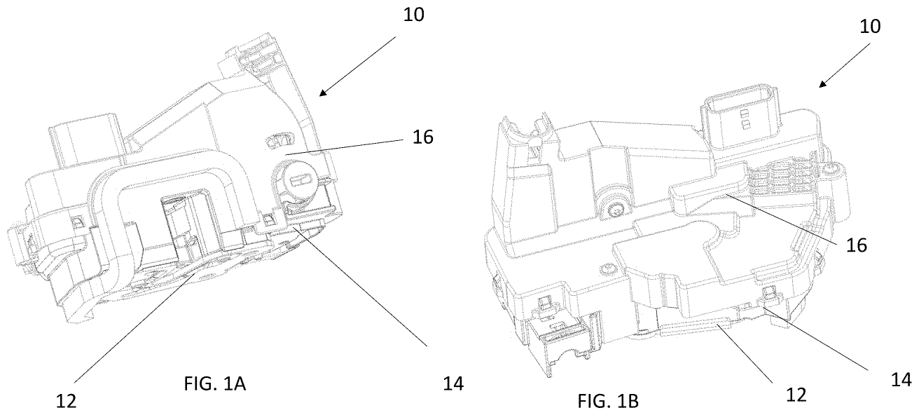

FIGS. 1A and 1B are perspective view of a vehicle latch 10 in accordance with an embodiment of the present disclosure. The vehicle latch 10 has a retention plate 12, a housing 14 and a cover 16. The retention plate 12 is secured to the housing 14 and the housing 14 is secured to the cover 16.

Referring now to at least FIGS. 1-14, the latch 10 also has a claw 18 and a pawl 20 each being pivotally mounted to the retention plate 12. The claw 18 is capable of rotation about a first stud or pin 19 and the claw is configured to engage and retain a striker (not shown) when it is received in the latch 10. The pawl 20 is a capable of rotation about a second stud or pin 21.

The claw 18 is capable of movement between a first or latched position or closed position or primary position wherein the striker is engaged by a throat of the claw 18 and a second or open position wherein the striker is free to be released from the throat of the claw 18. The retention plate 12 will also have a complimentary opening for receipt of the striker therein when it is engaged or latched by the claw 18. In one embodiment, the claw 18 may be spring biased into the second or open position by a spring or biasing member.

Alternatively or in addition to the spring biasing force applied to the claw, a movable member (e.g., door, panel, lift gate, etc.) the latch is secured to may also be spring biased or biased into an open position such that when the latch 10 is released claw 18 will rotate and release striker. One non-limiting example of an item providing such a force is the compressed weather stripping or sealing member located around the periphery of an opening that is covered by the movable member. In other words, when a vehicle door or other movable member is closed, the sealing member is compressed and the latch 10 engages the striker. Thereafter and when the latch 10 is released, the sealing member may provide an urging force to open the door or gate, etc.

During operation and in order to retain the latch 10 or claw 18 in the latched position, the pawl 20 is pivotally secured to the latch 10 for movement between an engaged position or latched position and a disengaged position or released position. When the pawl 20 is in the engaged position, a surface of the claw 18 is engaged by a surface of the pawl 20 and the claw 18 is prevented from moving toward the unlatched position from the latched position.

In one non-limiting implementation, a first spring may be provided for biasing the claw into the open position while a second spring may be provided for biasing the claw in the direction of the engaged position, such that movement of the claw to the latched position will cause the pawl to move to the engaged position.

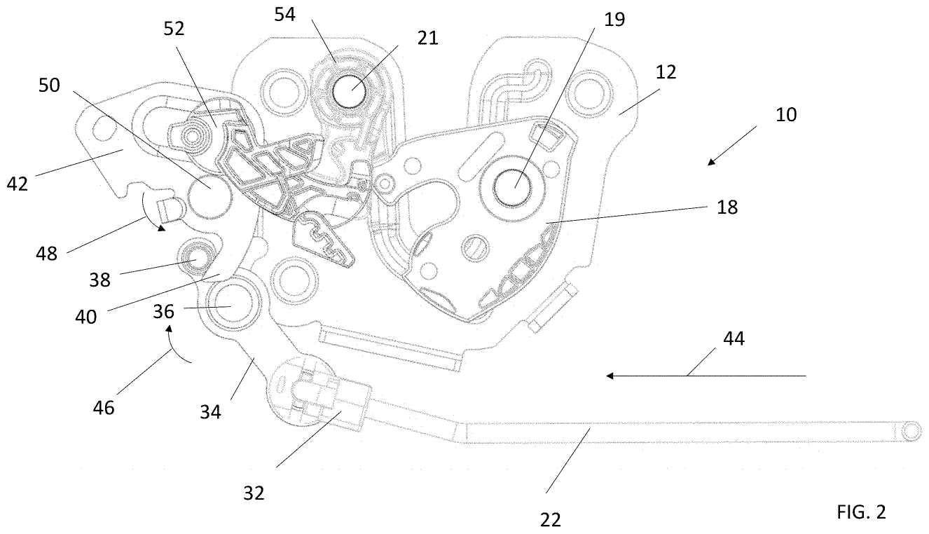

FIG. 2 is a view of components of a vehicle latch 10 that is common for use with cable and rod operated mechanisms in accordance with an embodiment of the present disclosure, wherein the latch is in an engaged primary position and a rod 22 is secured thereto.

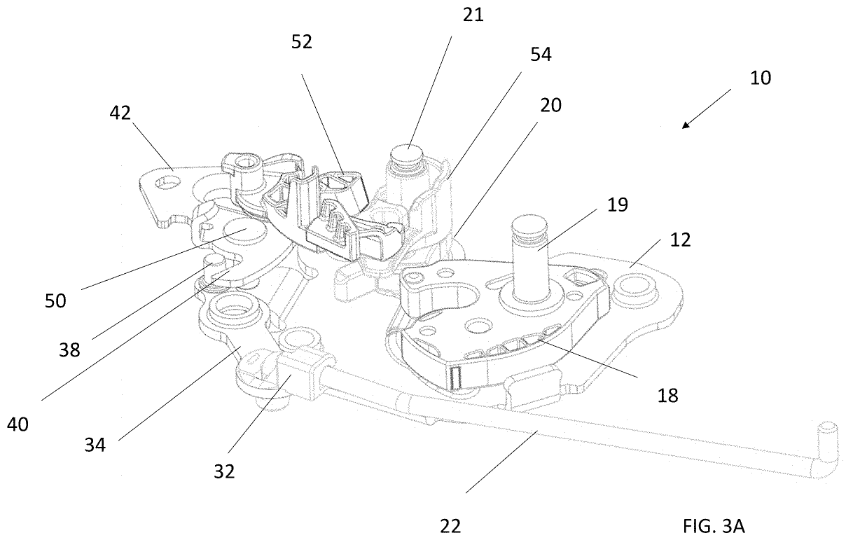

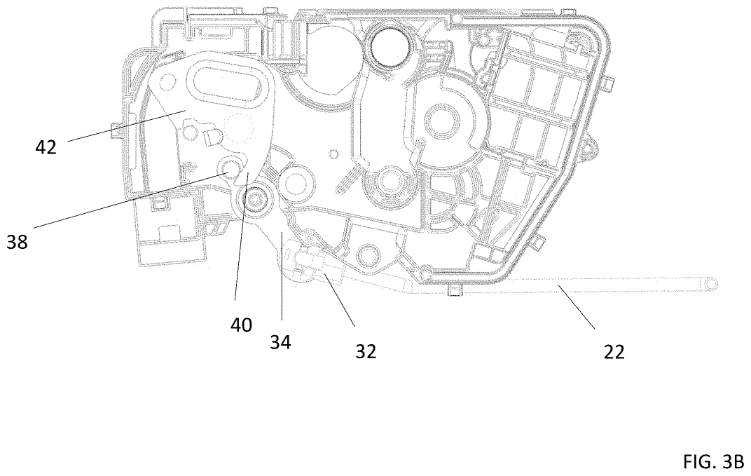

FIGS. 3A and 3B are perspective views of components of a vehicle latch 10 that is common for use with cable and rod operated mechanisms in accordance with an embodiment of the present disclosure, wherein the latch is in an engaged primary position and the rod 22 is secured thereto.

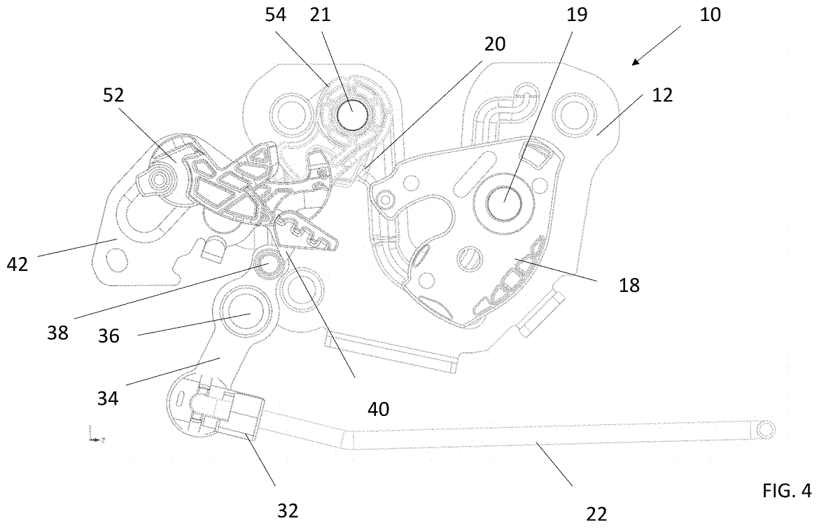

FIG. 4 is a view of components of a vehicle latch 10 that is common for use with cable and rod operated mechanisms in accordance with an embodiment of the present disclosure, wherein the release components of the latch are in a full open position and the rod 22 is secured thereto.

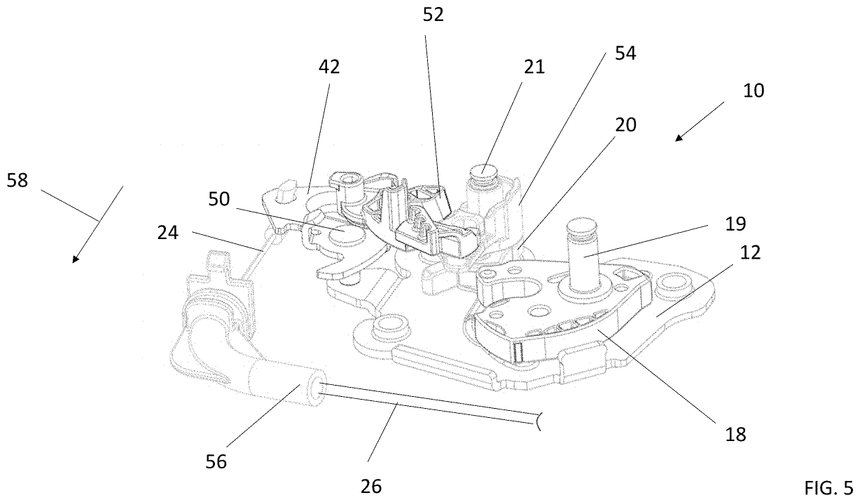

FIG. 5 is a view of components of a vehicle latch that is common for use with cable and rod operated mechanisms in accordance with an embodiment of the present disclosure, wherein the latch is in an engaged primary position and a cable 24 is secured thereto.

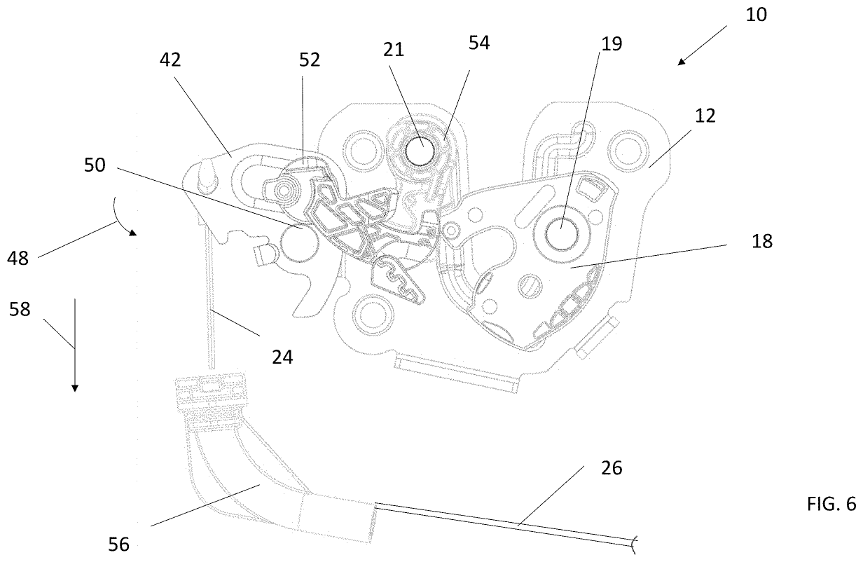

FIG. 6 is a view of components of a vehicle latch 10 that is common for use with cable and rod operated mechanisms in accordance with an embodiment of the present disclosure, wherein the release components of the latch are in a full engaged position and the cable 24 is secured thereto.

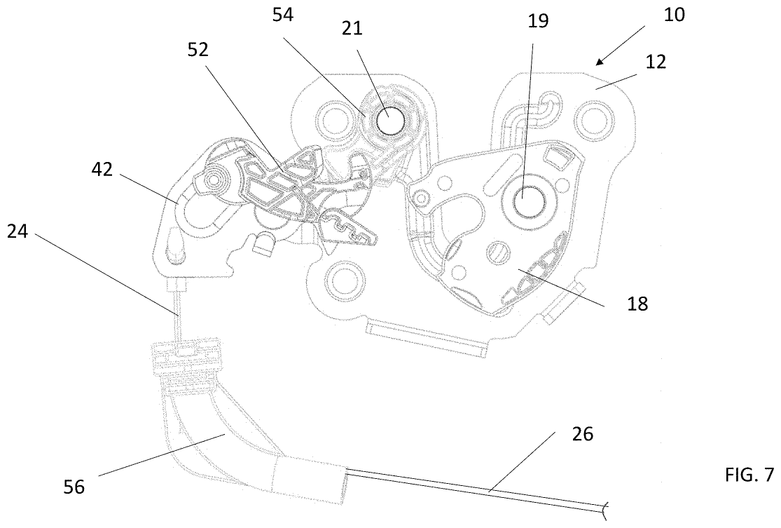

FIG. 7 is a view of components of a vehicle latch 10 that is common for use with cable and rod operated mechanisms in accordance with an embodiment of the present disclosure, wherein the release components of the latch are in a full open position and the cable 24 is secured thereto.

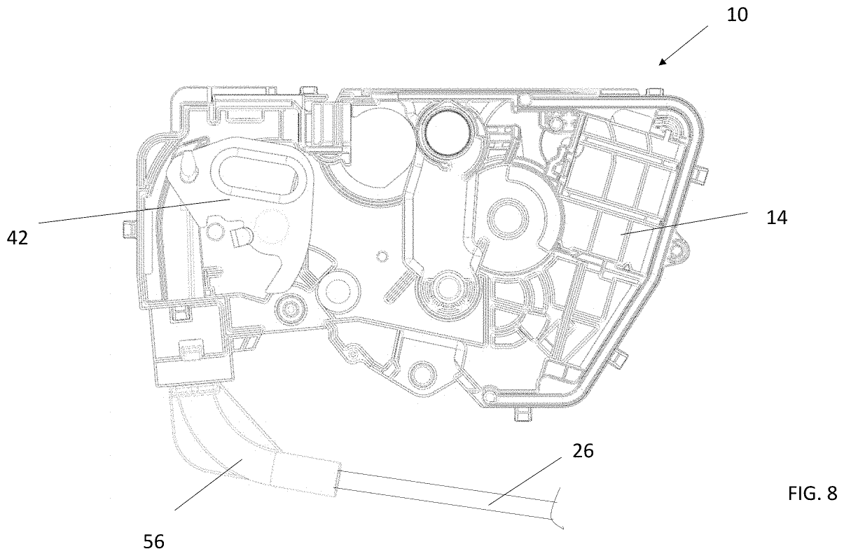

FIG. 8 is a view of components of a vehicle latch 10 that is common for use with cable and rod operated mechanisms in accordance with an embodiment of the present disclosure, wherein the latch is in an engaged primary position and the cable conduit end-fitting 56 is secured to the latch housing.

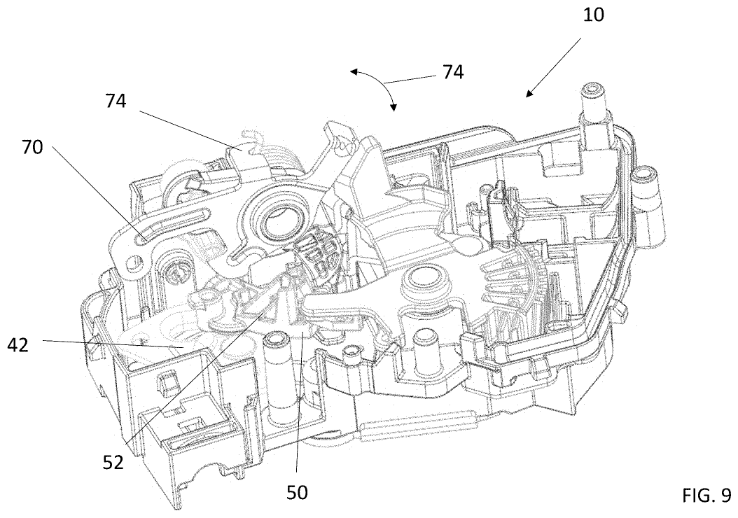

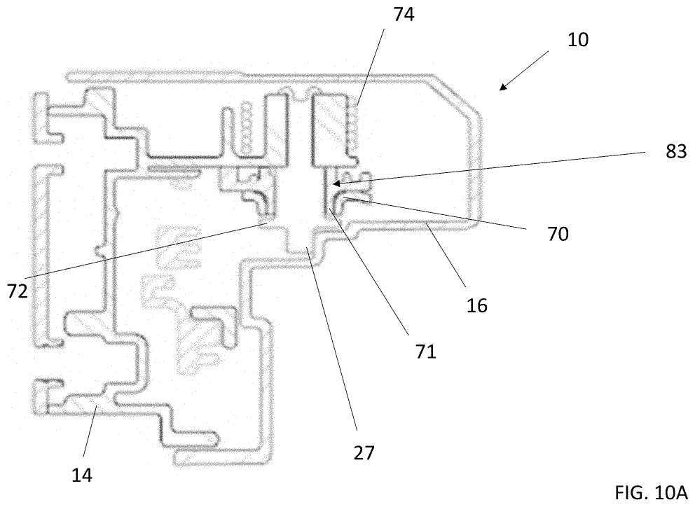

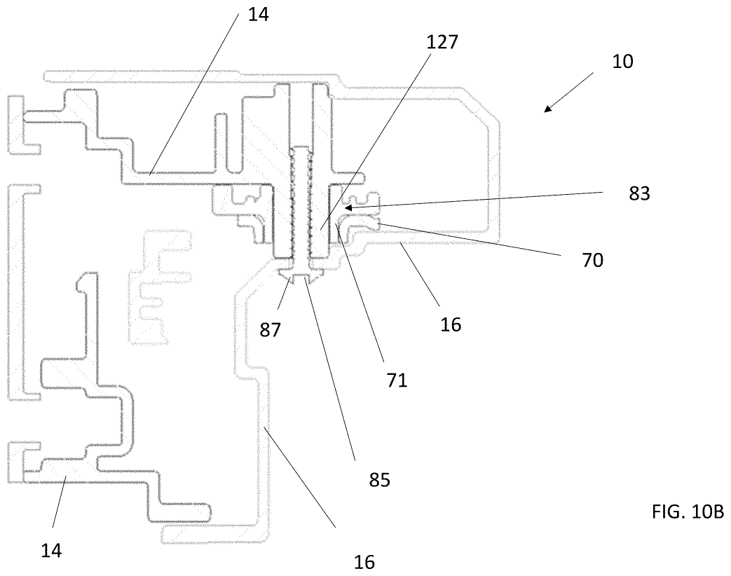

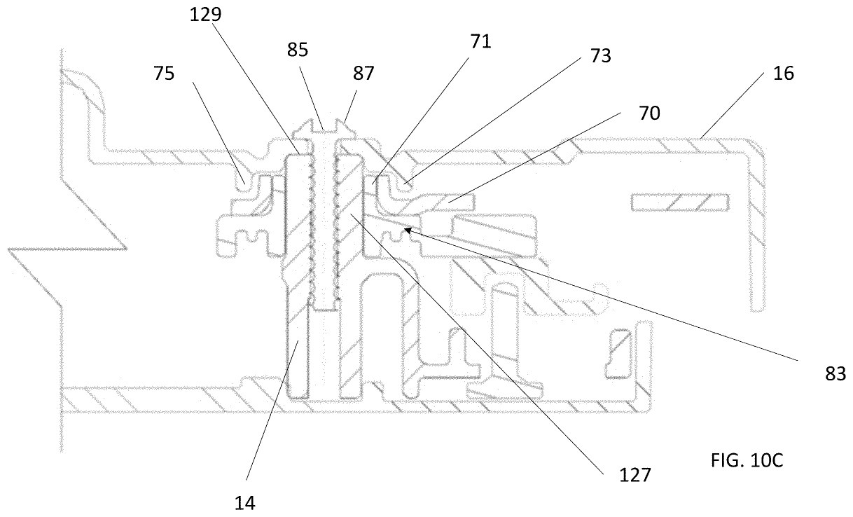

FIGS. 9 and 10 are portions of the latch showing a pivot 27 for components of a latch in accordance with an embodiment of the present disclosure.

FIG. 10B illustrates portions of the vehicle latch in accordance with an alternative embodiment of the present disclosure.

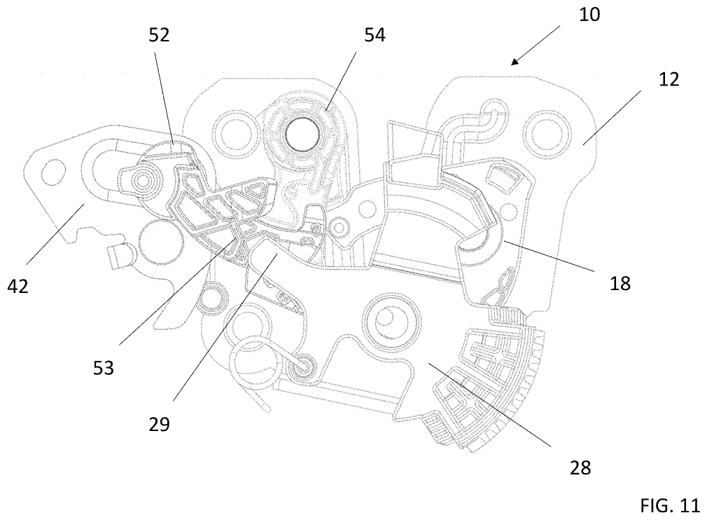

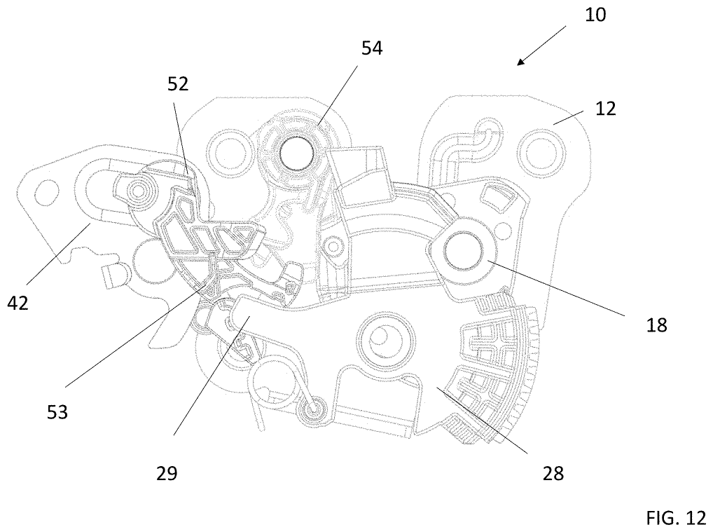

FIGS. 11 and 12 are views of components of a vehicle latch 10 that is common for use with cable and rod operated mechanisms is illustrated in accordance with an embodiment of the present disclosure. Here, the central door lock sector 28 of the vehicle latch 10 is common for use with cable and rod operated mechanisms.

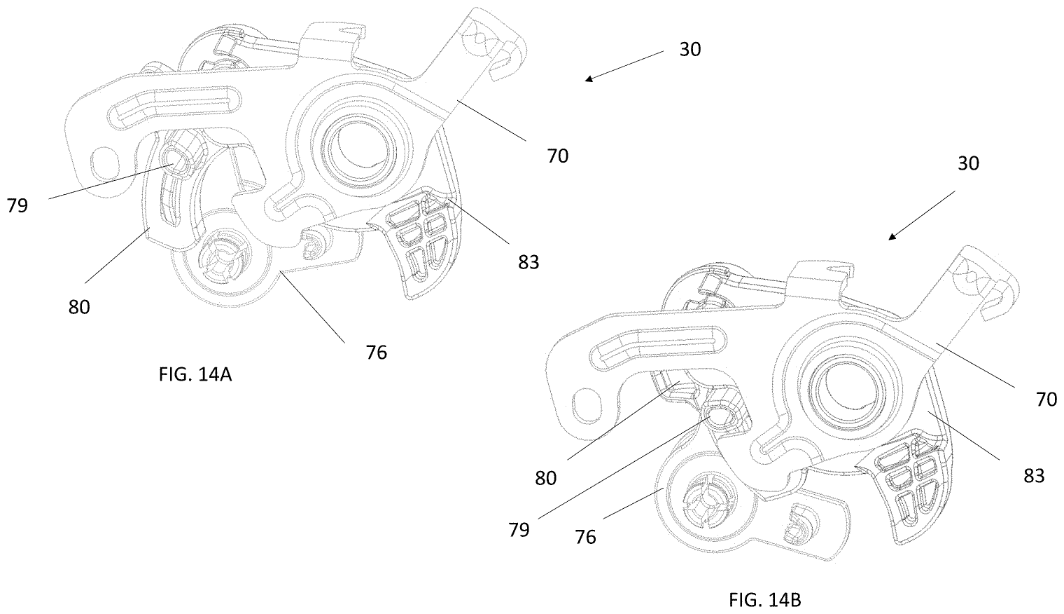

FIG. 14 illustrates a mechanical child lock mechanism 30 for use with a vehicle latch 10 in accordance with an embodiment of the present disclosure.

Referring now to FIGS. 2-4, the vehicle latch 10 is operated with a rod 22 secured thereto. In one embodiment, the rod 22 is operatively coupled to an outside door handle that the vehicle latch 10 is associated with. The rod 22 has a rod clip 32 at one end. The rod clip 32 is secured to a rod lever 34 that is pivotally mounted to a pivot 36 of the vehicle latch 10. The rod lever has a protrusion or member 38 that contacts an arm or portion 40 of an outside handle lever 42.

Movement of the rod 22 in the direction of arrow 44 via operation of the outside door handle will cause a corresponding movement of rod lever 34 in the direction of arrow 46 about pivot 36, which in turn will cause outside handle lever 42 to move in the direction of arrow 48 about pivot 50 the outside handle lever 42 is pivotally secured to. The pivot 50 is secured to the retention plate 12.

The outside handle lever 42 is operatively coupled to a lock lever 52 and the lock lever 52 is operatively coupled to a pawl lifter 54, which is in turn coupled to the pawl 20. Thus, desired movement of the pawl 20 is facilitated through movement of the rod 22 in the direction of arrow 44. It being understood that the outside handle lever 42 is spring biased into the position illustrated in at least FIG. 2 by a spring (see FIG. 9), such that after the rod 22 is moved in the direction of arrow 44 to the position illustrated in at least FIG. 4 and the force moving the rod in the direction of arrow 44 is no longer being applied the rod 22, the rod 22 and the components associated with it (e.g., rod lever 34, outside handle lever 42, lock lever 52, pawl lifer 54, etc.) will move back to the positions illustrated in at least FIGS. 2 and 3 due to the outside handle lever 42 being spring biased back in a direction opposite to arrow 48 and into the position illustrated in at least FIG. 2 by spring.

In FIGS. 3A and 3B the latch 10 is in an engaged primary position via movement of the rod 22 while in FIG. 4 the vehicle latch 10 is in a full open position and FIG. 5 the latch 10 is in an engaged primary.

Referring now to FIGS. 5-8, the vehicle latch 10 is operated with a cable 26 secured thereto instead of rod 22. In one embodiment, the cable 26 is operatively coupled to the outside handle lever 42 at one end and the cable is operatively coupled to the outside door handle that the vehicle latch 10 is associated with another end. As such, movement of the cable in direction of arrow 58 will cause outside handle lever 42 to move in the direction of arrow 48 about pivot 50 the outside handle lever 42 is pivotally secured to.

As mentioned above, the outside handle lever 42 is operatively coupled to the lock lever 52 and the lock lever 52 is operatively coupled to the pawl lifter 54, which is in turn coupled to the pawl 20. Thus, desired movement of the pawl 20 is facilitated through movement of the cable 26 in the direction of arrow 58. It being understood that the outside handle lever 42 is spring biased into the position illustrated in at least FIGS. 5 and 6 by spring, such that after the cable 26 is moved in the direction of arrow 58 to the position illustrated in at least FIG. 7 and the force moving the cable in the direction of arrow 58 is no longer being applied to the cable 26 and the components associated with it (e.g., rod lever 34, outside handle lever 42, lock lever 52, pawl lifer 54, etc.) they will move back to the positions illustrated in at least FIGS. 2 and 3 due to the outside handle lever 42 being spring biased back in a direction opposite to arrow 48 and into the position illustrated in at least FIG. 6 by spring.

The cable 24 passes through a cable connector 56 that is secured to the housing 14. In one embodiment, a cable sheath 26 surrounds the cable 24 and extends from the cable connector 56 toward the outside door handle the cable 24 is secured to.

Referring now to FIGS. 2-8, the outside handle lever 42 design or configuration is common for rod or cable actuated latches thus, a latch 10 is provided with an outside handle lever that can be operated by a rod 22 or a cable 24.

Referring now to FIGS. 9 and 10A portions of the latch showing a pivot 27 for components of a latch in accordance with an embodiment of the present disclosure. Here an inside release lever 70 and an inside release bypass lever 83 are pivotally mounted to the housing 14 via a pivot 27. The pivot 27 has a shoulder portion 72 for retaining the inside release lever 70 and the inside release bypass lever 83 against the housing 14. In addition, a boss or pivot or inside release pivot 71 is provided on the inside release bypass lever 83 that is rotatably received on the pivot 27. In this embodiment, the boss or pivot or inside release pivot 71 is integrally formed with the inside release bypass lever 83 such that they are formed as a single component. In one non-limiting embodiment, the cover 16 and the housing 14 are formed from a easily moldable material such as plastic. In this embodiment, and since the boss or pivot or inside release pivot 71 is integrally formed with the inside release bypass lever 83 and they are a separate component with respect to the housing 14 and the cover 16 they can be formed from a separate material than the housing 14 and the cover 16. As such, the inside release lever 70 is rotatably received on the boss or pivot or inside release pivot 71 of the inside release bypass lever 83. In one non-limiting embodiment and when the boss or pivot or inside release pivot 71 is a portion of the inside release bypass lever 83 and is separate component with respect to the housing 14 and the cover 16, the boss or pivot or inside release pivot 71 and the inside release bypass lever 83 may be formed from a separate material such as steel or any other equivalent material. In addition, the pivot 27 may also be formed from a separate material with respect to the housing 14 and the cover 16 such as steel or any other equivalent material. When the pivot 27 is secured to the housing the shoulder portion 72 of the pivot 27 retains the inside release lever 70 against the boss or pivot or inside release pivot 71 of the inside release bypass lever 83.

In one embodiment, the inside release lever 70 is operatively coupled to an inside release handle of the vehicle door by a cable or rod and is configured for movement in the directions of arrows 74 about pivot 27. Also, shown is that the inside release lever 70 is operatively coupled to lock lever 52 such that movement of the inside release lever 70 will cause the desired movement of lock lever 52 and accordingly operation of the latch 10. Also illustrated is a spring 74 for providing a biasing force opposite to the directional movement of the inside release lever 70 when it is moved by the inside release handle.

Referring now to FIGS. 9, 10B and 10C portions of a latch in accordance with another embodiment of the present disclosure is illustrated. Here the pivot 27 is removed as it is no longer necessary and the inside release bypass lever 83 is rotatably mounted on a boss or pivot 127, which is formed as a portion of the housing 14 such that the boss or pivot 127 is formed as a single component with the housing 14. As such and in one embodiment and when the housing is formed from plastic the boss or pivot 127 is also formed from plastic. In addition and similar to the FIG. 10A embodiment, the inside release lever 70 is pivotally mounted on the boss or pivot or inside release pivot 71, which is a portion of the inside release bypass lever 83. In one embodiment, the housing 14, the cover 16 and the integral boss or pivot 127 are formed from a easily moldable material such as plastic. In addition and in this embodiment, the boss or pivot 127 is integrally formed with the housing 14 such that the housing 14 and the boss or pivot 127 are the same component.

As such, the inside release lever 70 is rotatably received on the boss or pivot or inside release pivot 71. In this embodiment, the boss or pivot or inside release pivot 71 is at least partially located between the inside release lever 70 and the boos or pivot 127 of the housing 14 as the boss or pivot 127 extends outwardly from the housing 14 and the cover 16 is configured to retain the inside release lever 70 and the inside release bypass lever 83 on the boss or pivot 127 as well as to retain the inside release lever 70 on the boss or pivot or inside release pivot 71 of the inside release bypass lever 83. In order to do this a screw or fastener 85 is used to secure the cover 16 to the housing 14. In addition, the cover 16 is configured to retain the inside release lever 70 on the boss or pivot or inside release pivot 71 of the inside release bypass lever 83 as well as retain the inside release bypass lever 83 against the housing 14 while still allowing for pivotal or rotational movement of the inside release bypass lever 83 on the boss or pivot 127 and pivotal or rotational movement of the inside release lever 70 on the boss or pivot or inside release pivot 71 of the inside release bypass lever 83.

For example and referring now to FIG. 10C, the cover 16 includes two retaining features 73, 75 to hold the inside release lever 70 on the boss or pivot or inside release pivot 71 of the inside release bypass lever 83. A first one of the two retaining features (illustrated by reference numeral 73) is located at the tip of the boss or pivot or inside release pivot 71 of the inside release bypass lever 83 where the inside release lever 70 is rotationally received such that a portion of the release lever 70 is located between feature 73 and a portion of the boss or pivot or inside release pivot 71 of the inside release bypass lever 83 and a second one of the two retaining features or the other feature 75 is located on opposing side such that a portion of the release lever 70 is located between feature 75 and the boss or pivot or inside release pivot 71 of the inside release bypass lever 83. Thereafter, the screw or fastener 85 holds the housing 14 and cover 16 together and a portion of the release lever 70 is moveably secured between the two features 73 and 75 and the boss or pivot or inside release pivot 71 of the inside release bypass lever 83. In addition, the inside release bypass lever 83 is rotatably received on the integral pivot 127 of the hosing 14. For example, the screw or fastener 85 passes through an opening in the cover 16 and threadingly engages a threaded opening in the pivot 127 of the housing 14. A head 87 of the screw or fastener 85 is larger than the opening in the cover 16. In one non-limiting embodiment, the screw or fastener 85 may be a self-tapping screw.

In addition, the cover 16 may also include a receiving area or cavity 129 for receiving a portion of the pivot 127 therein.

Accordingly, the latch housing 14 and the cover 16 are configured to eliminate the need for one component namely the pivot 27 shown in at least FIG. 10A. As such, the inside release lever metal pivot 27 was replaced by the plastic boss or pivot 127 attached on or a portion of the latch housing 14 and the cover 16 is configured to have two retaining features 73 and 75 to hold the inside release lever 70 and the boss or pivot 127 in position during operation of the latch 10.

As in the previous embodiment, the inside release lever 70 is operatively coupled to an inside release handle of the vehicle door by a cable or rod and is configured for movement in the directions of arrows 74 (FIG. 9) about pivot 71. Also shown is that the inside release lever 70 is operatively coupled to lock lever 52 such that movement of the inside release lever 70 will cause the desired movement of lock lever 52 and accordingly operation of the latch 10. Also illustrated is a spring 74 for providing a biasing force opposite to the directional movement of the inside release lever 70 when it is moved by the inside release handle.

Referring now to FIGS. 11 and 12 views of components of a vehicle latch 10 that is common for use with cable and rod operated mechanisms is illustrated in accordance with an embodiment of the present disclosure. Here, the central door lock sector 28 of the vehicle latch 10 is common for use with cable and rod operated mechanisms. The central door lock sector 28 directly operates the lock lever 52 from an unlock position to a lock position and vice versa. During the movement of the lock lever 52 into the unlock position the following occurs: when the lock lever 52 is in the unlock position, the outside release mechanism is enabled. On the other hand, when the lock lever is in lock position, the outside release mechanism is disabled. In FIG. 12, the lock lever 52 is in the lock position. In other words, there is no intermediary components between a portion 29 of the central door lock sector 28 that contacts a portion 53 of the lock lever 52. The latch 10 and the central door lock sector 28 is designed in a way to reduce the number of components needed for this function.

In addition, the central door lock sector 28 lever in the same plane as the actuator, which allows the size of the latch to be reduced.

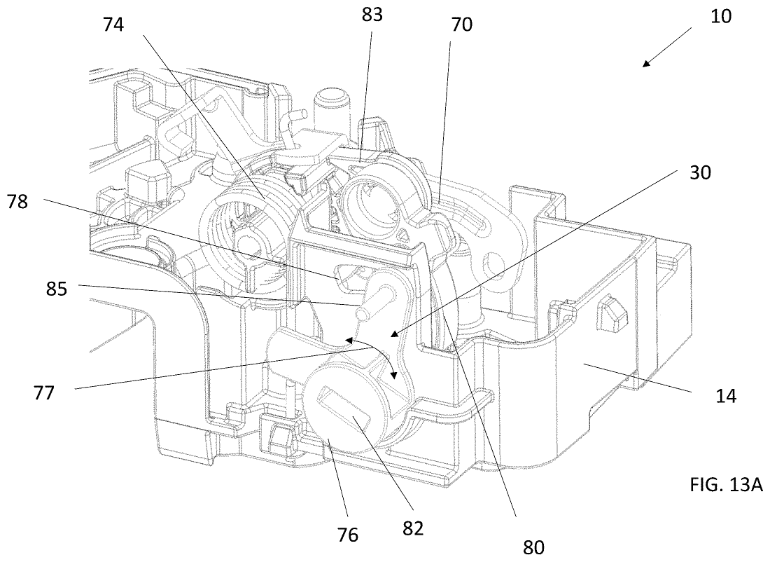

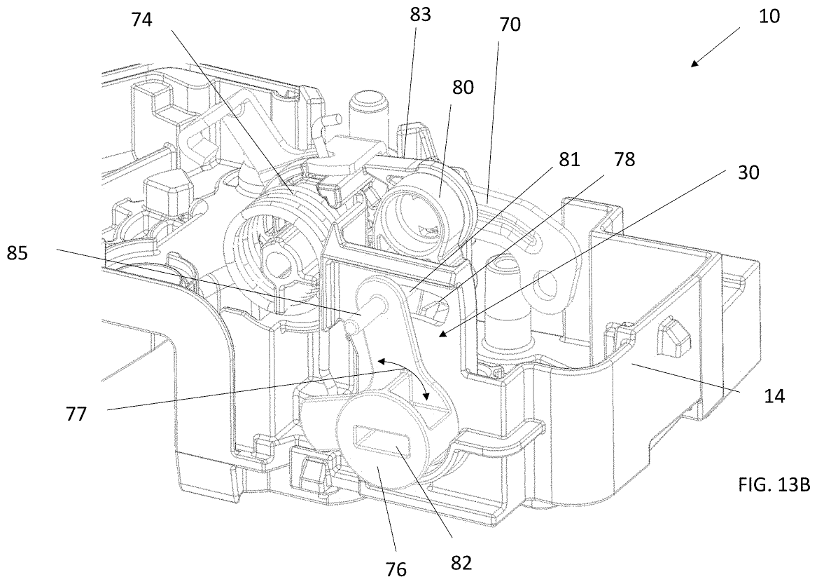

Referring now to FIGS. 13A and 13B, a mechanical child lock mechanism 30 for use with the vehicle latch 10 in accordance with an embodiment of the present disclosure is illustrated. In some applications (e.g., where the vehicle latch 10 is used in a rear door of the vehicle) it is desirable to have the mechanical child lock mechanism 30. FIG. 13A illustrates the mechanical child lock mechanism 30 in a locked position while FIG. 13B illustrates the mechanical child lock mechanism 30 in an unlocked position. In other applications, (e.g., where the vehicle latch 10 is used in a front door of the vehicle) the mechanical child lock mechanism 30 may not be needed. The mechanical child lock mechanism 30 can be operated manually or by a key. When operated the child lock mechanism 30 prevents the vehicle latch 10 from being opened through operation of a vehicle inside door handle operably coupled to the vehicle latch 10. The mechanical child lock mechanism 30 includes a child lock lever 76 that is rotatably mounted to housing 14 for movement in the directions of arrows 77. A portion 81 of the child lock lever 76 extends through a slot 78 in the housing 14 which operably couples the child lock lever 76 to child lock link 80 such that movement of the child lock lever 76 in the direction of arrows 77 will cause a corresponding movement of the child lock link 80 in order to position the child lock link 80 in a position that will cause the latch 10 to not be opened if an inside door handle of the vehicle is operated. Another portion 85 of the child lock lever 76 extends through a slot in the cover 16 so that the child lock lever 76 may be moved (e.g., manually manipulated) in the direction of arrows 77.

The child lock link 80 is mounted on an inside release bypass lever 83 and it can rotate around the mounting pivot hole on the inside release bypass lever 83. When the child lock lever 76 is rotated in the directions of arrows 77, it interacts with and rotates the child lock link 80 from an engaged position to a disengaged position and vice versa. When the child lock link 80 is in the engaged position, the inside release lever 70 interacts and moves the inside release bypass lever 83 through the child lock link 80 during the actuation of the vehicle inside release handle. On the other hand, when the child lock link 80 is in the disengaged position, the inside release lever 70 is not able to mechanically interact and move the inside release bypass lever 83 through the child lock link 80 during the actuation of the vehicle inside release handle.

The child lock lever 76 includes a slot 82 that allows a key or tool to be inserted into the slot in order to rotate it in the direction of arrows 77. In addition, the child lock lever 76 also includes an extension or arm 84 that extends from the child lock lever. The extension or arm 84 extends outwardly from the cover 16 of the latch so that child lock lever 76 may be manipulated in the directions of arrows 77 without the need to use a tool or key inserted in slot 82. In other words, a user may manipulate the child lock lever 76 with their hand by engaging the extension or arm 84 that extends from the cover 16 of the latch 10.

FIGS. 14A and 14B illustrate components of the mechanical child lock mechanism 30. In FIG. 14A, the mechanical child lock mechanism 30 is in a locked position while in FIG. 14B the mechanical child lock mechanism 30 is in a locked position. In FIG. 14B, a protrusion 79 of the child lock link 80 is located between the inside release lever 70 and the inside release bypass lever 83 so that the inside release lever 70 is able to mechanically interact and move the inside release bypass lever 83 during the actuation of the vehicle inside release handle. Alternatively and in FIG. 14A, the protrusion 79 of the child lock link 80 is not located between the inside release lever 70 and the inside release bypass lever 83 due to rotation of the child lock lever 76 so that the inside release lever 70 is not able to mechanically interact and move the inside release bypass lever 83 during the actuation of the vehicle inside release handle.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A vehicle latch (10), comprising:
a retention plate (12);
a housing (14);
a cover (16), the retention plate being secured to the housing and the housing is secured to the cover;
a claw (18) pivotally mounted to the retention plate;
a pawl (20) pivotally mounted to the retention plate;
an outside handle lever (42) securable to either a rod (22) or a cable (24) located outside of the housing of the latch;
an inside release lever (70) that is pivotally mounted to the housing (14) via a pivot (127), the pivot (127) being integrally formed with the housing (14) such that they are formed as a single component, wherein the cover (16) includes two retaining features to hold the inside release lever (70) in position on the pivot (127), a first one (73) of the two retaining features is located proximate to a tip of the pivot (127) and a second one (75) of the two retaining features is located at an opposite side of the tip of the pivot (127) such that portions of the release lever (70) is rotationally received between the two retaining features (73, 75); and
a fastener for securing the cover (16) to the housing (14).

2. The vehicle latch (10) as in claim 1, wherein the rod is secured to the outside handle lever with a rod lever (34) pivotally mounted to the retention plate.

3. The vehicle latch (10) as in claim 2, wherein the outside handle lever is operatively coupled to a lock lever (52) and the lock lever (52) is operatively coupled to a pawl lifter (54), which is in turn coupled to the pawl.

4. The vehicle latch (10) as in claim 3, wherein the outside handle lever is spring biased a spring.

5. The vehicle latch (10) as in claim 1, wherein the outside handle lever is spring biased a spring.

6. The vehicle latch (10) as in claim 1, wherein the outside handle lever is operatively coupled to a lock lever (52) and the lock lever (52) is operatively coupled to a pawl lifter (54), which is in turn coupled to the pawl.

7. The vehicle latch (10) as in claim 1, wherein a cable (24) is secured to the outside handle lever.

8. The vehicle latch (10) as in claim 7, wherein the outside handle lever is spring biased a spring.

9. The vehicle latch (10) as in claim 7, wherein the outside handle lever is operatively coupled to a lock lever (52) and the lock lever is operatively coupled to a pawl lifter (54), which is in turn coupled to the pawl.

10. The vehicle latch (10) as in claim 7, wherein the cable passes through a cable connector (56) that is secured to the housing.

11. The vehicle latch (10) as in claim 1, wherein the inside release lever is operatively coupled to a lock lever (52) such that movement of the inside release lever will cause the desired movement of lock lever and accordingly operation of the latch.

12. The vehicle latch (10) as in claim 1, further comprising a spring (74) for providing a biasing force to the inside release lever.

13. The vehicle latch (10) as in claim 1, further comprising a central door lock sector (28) that is configured for use with the cable or the rod.

14. The vehicle latch (10) as in claim 1, further comprising a mechanical child lock mechanism (30), the mechanical child lock mechanism includes a child lock lever (76) that is rotatably mounted to housing, a portion of the child lock lever extending through a slot (78) in the housing which operably couples the child lock lever to a child lock link (80) such that movement of the child lock lever will cause a corresponding movement of the child lock link, and the child lock lever includes a slot (82) that allows a key or tool to be inserted into the slot in order to rotate the child lock lever, and an extension (84) that extends from the child lock lever, the extension extends outwardly from the cover of the latch so that child lock lever (76) may be manipulated without a tool or key inserted in slot.

15. The vehicle latch (10) as in claim 14, wherein the rod is secured to the outside handle lever with a rod lever (34) pivotally mounted to the retention plate.

16. The vehicle latch (10) as in claim 15, wherein the outside handle lever is operatively coupled to a lock lever (52) and the lock lever (52) is operatively coupled to a pawl lifter (54), which is in turn coupled to the pawl.

17. The vehicle latch (10) as in claim 14, wherein a cable is secured to the outside handle lever.

18. The vehicle latch (10) as in claim 17, wherein the outside handle lever is operatively coupled to a lock lever (52) and the lock lever is operatively coupled to a pawl lifter (54), which is in turn coupled to the pawl.

19. The vehicle latch (10) as in claim 1, further comprising an inside release bypass lever (83) rotatably received on the pivot (127) and the inside release lever (70) is rotatably received on the inside release bypass lever (83).

20. The vehicle latch (10) as in claim 19, wherein the pivot the inside release bypass lever (83) is integrally formed with a boss (71) extending from the inside release bypass lever (83), the inside release bypass lever (83) and the boss (71) being formed as a single component and the inside release leaver (70) is rotatably received on the boss (71) of the inside release bypass lever (83).
